(19) United States
(12) Patent Application Publication
(10) Pub. No.: US 2009/0207033 A1
(43) Pub. Date: Aug. 20, 2009

(54) Device and A Method For Detection Of and Warning Against Tsunamis

(76) Inventor: Sigurd Melin, Nasviken (SE)

Correspondence Address: YOUNG & THOMPSON, 209 Madison Street, Suite 500, ALEXANDRIA, VA, 22314, US

(21) Appl. No.: 11/794,670

(22) PCT Filed: Jan. 3, 2006
(86) PCT No.: PCT/SE2006/000005

§ 371 Date: Aug. 9, 2007

(30) Foreign Application Priority Data
Jan. 3, 2005 (SE) 0500007-0
Nov. 14, 2005 (SE) 0502490-6

(51) Int. Cl. G08B 21/10

(52) U.S. Cl. 340/626

(57) ABSTRACT

A device for detection of and warning against tsunamis. The device is characterized in that it includes a stationary base unit (2) and at least one courier (6) disengagably connected to the base unit (2), elements (3, 4, 5) for detection of the fulfillment of a predetermined condition, and elements (15) for releasing the courier from the base unit when the condition is fulfilled, the courier (6) including elements (10, 11, 12) in order to communicate to an external receiver that it is released from the base unit (2). A method for detection of and warning against tsunamis is also disclosed.

### TECHNICAL FIELD OF THE INVENTION

This invention relates to a device for automatic detection of and warning against tsunamis, intended to be located on the seabed, comprising a sensor, e.g. a pressure sensor, a processor, a power source as well as one or more disengagable parts, each provided with a radio transmitter and a power source of its own.

### BACKGROUND OF THE INVENTION AND PRIOR ART

A tsunami that strikes a coast is a very insidious type of natural disaster, since it is hardly noticed before it approaches land. That was the circumstances around the wave that caused death and holocaust in the Indian Ocean in December 2004. A several meter high wave that strikes a coast, needs to be just a few decimeters high as long as it travels over the deep sea, Since the wave at the same time may have a wavelength of several kilometers, is it not detectable without instruments.

Such instruments are developed. By measuring the variations of the water level, or of the water pressure at great depths, a passing tsunami may be detected. In the Pacific Ocean a system of such measuring points reports via buoys and satellites to a surveillance centre that may determine the size and travel direction of the tsunami and send out a warning to the threatened areas.

However, during the time, which is needed to detect, analyze and warn against a tsunami, the same manage to travel a considerable distance, since its speed over the deep sea may amount to over 800 km/h. This implies that communities located close to the triggering quake are not warned in time. There are also local tsunamis that are not caught in a scattered large scale surveillance system as the one around the Pacific Ocean. Such a tsunami stroke New Guinea in 1998.

Another problem is to get the transmitted warning out to the people that for the moment are in the danger zone quickly enough.

These large scale “early warning systems” have their natural role, but in addition to this there are needed local tsunami warning systems that may detect a tsunami approaching the coast and quickly warn those being in the danger zone. This requires tsunami detectors, which are automatic as well as cheap. Automatic in order to be able to be connected directly to, for instance, sirens on land, and cheap in order not to get the detectors too scattered.

The equipment that is used today is based on deep sea buoys that have to be robust, carefully anchored and of high quality in order to manage the strain they are exposes to in the shape of great waves and such. This makes them quit expensive.

A local automatic tsunami detection device is previously known by the SE patent application 0500007-0. This is located on the seabed and feels the pressure change that is caused by a passing tsunami. An ascent mechanism is then activated and the device ascends to the surface. From that place a radio signal is transmitted to a receiver on land, which in turn activates an alarm, e.g. in the shape of sirens.

The drawback of this device is that the same has to be taken care of after the triggered alarm, restored in an active state and once again be placed on the seabed. Thereto, the operability may not be tested without carrying out the entire procedure.

### OBJECTS AND FEATURES OF THE INVENTION

The present invention aims at providing an automatically operating tsunami detector, which is simple, cheap and reliable, which may be part of a large scale tsunami surveillance system as well as of a local independent tsunami warning system, and which without maintenance needs may be used several times and the function of which may be tested at predetermined time interval.

The device comprises a stationary base unit, which accommodate a sensor, e.g. a pressure sensor, a processor and a power source, e.g. a battery, as well as a number of attached parts “couriers” that may be released one by one. It is located on the seabed where it continuously measures a physical quantity, preferably the water pressure. A passing tsunami results in a characteristic change of the water pressure at the seabed. This pressure change is identified by the processor, which activates a mechanism that releases one of the couriers. This ascend to the surface and transmits a radio signal therefrom that may be received, preferably on land by a receiver connected to a siren, but also by a satellite for further forwarding to a surveillance center for a larger area.

The couriers are preferably shaped as torpedo like projectiles, which are lighter than water, i.e. having a lower density than water, in order to make the ascending time to the surface as short as possible.

On the seabed the device may be left in peace from storms, the oxygen of the air, people who can't leave things alone and other threats. This entails that it may be made relatively small, simple and cheap.

In order to regularly be able to test that the device (and the system into which it belongs) works as intended, the processor may have an instruction that at predetermined intervals temporarily reduce the criteria for alarm to a level at which the device also warn against the smaller or slower pressure changes that always occurs, but also for the variations in the reported measured values that are in consequence of the imperfection of the pressure sensor. After the processor has reacted, released a courier and thereby triggered a alarm, it returns to normal instructions.

### SHORT DESCRIPTION OF THE APPENDED DRAWINGS

FIG. 1 shows the device in an active state on the seabed 1, on which it is located having its heavier end somewhat sunk into the seabed sediment. The device consists of a stationary base unit 2, which accommodates the sensor 3, a processor 4 and a power source 5 as well as a number of attached parts 6, “couriers”, which may be released one by one. In the figure are two of these shown; one that has not yet been released and one that just has been released and is on its way to ascend. The stationary part has a watertight pressure durable casing 7 and is preferably provided with a lifting device 8.

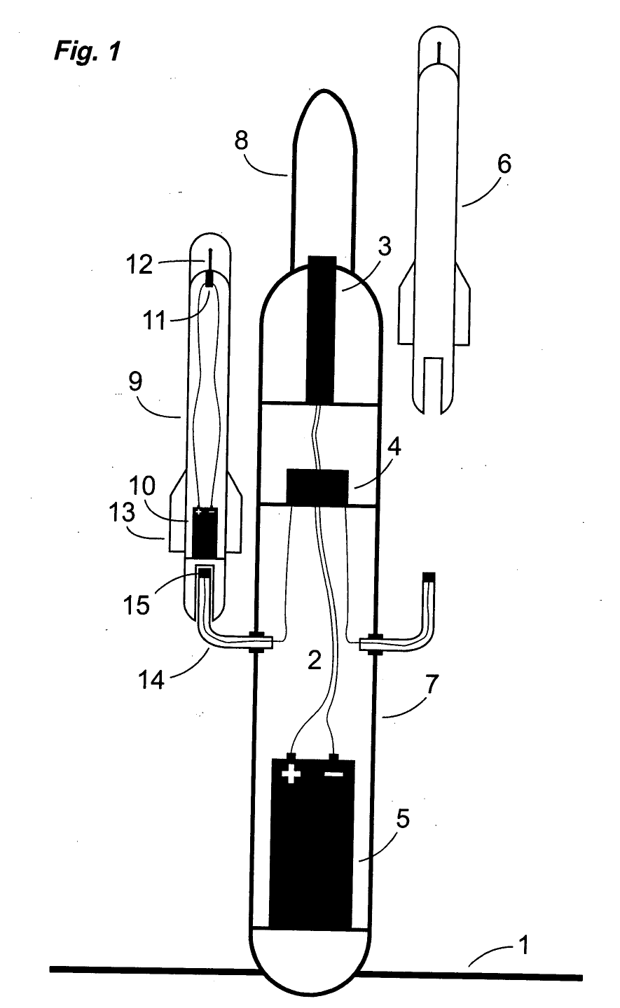

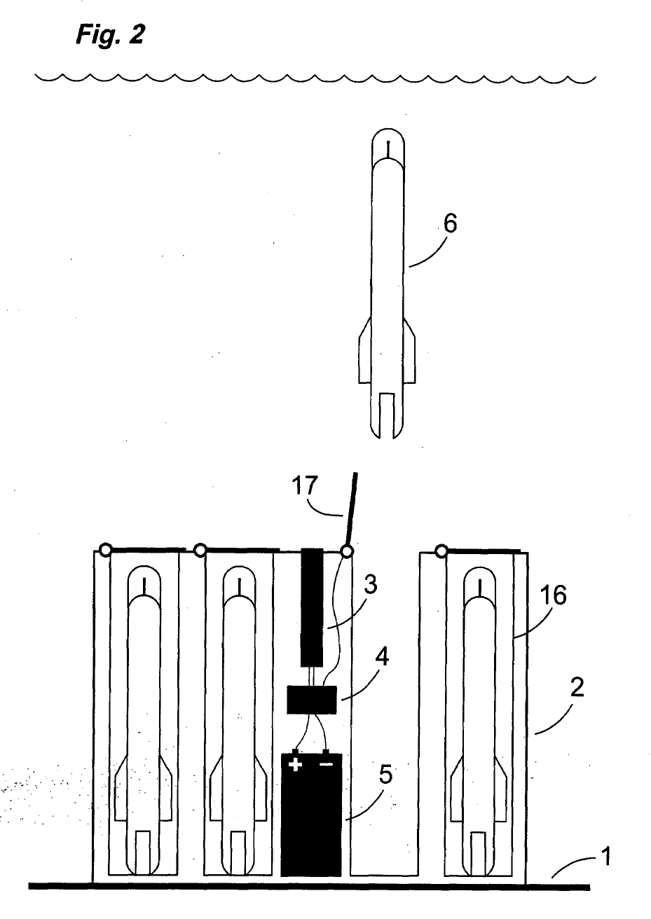

Each courier consists of a watertight pressure durable casing 9, a power source 10, a radio transmitter 11 as well as an antenna 12 mounted in the upper end of the courier. The courier also has fins 13 for a more stable ascension to the surface. The attachment device 14 consists, in this case, of a bent tube mounted into the stationary part, and through which a cable runs to the release mechanism 15, which in this case may consist of a small explosive charge that ejects the courier on a signal from the processor.

In FIG. 2 is shown an alternative embodiment, in which the couriers are located in separate watertight compartments 16, four of which is shown in the figure. The release mechanism consists, in this case, of a lid 17 that is opened on a signal from the processor, the courier being released by its own buoyancy from the stationary part. In the figure is shown, as an example, only the connection to one of these lids, which has just been opened and thereby released a courier. Alternatively, a gas ampoule (not shown) may be used. When it is triggered on a signal from the processor a gas is released that creates an overpressure in the relevant compartment, enough to blow away the lid 17.

### DETAILED DESCRIPTION OF PREFERRED EMBODIMENTS OF THE INVENTION

Ordinary ocean waves consist of the visible wave on the surface as well as a shock wave below the surface. The increase in pressure that the passing ordinary wave creates may only be registered close under the wave. At greater depths is it calm and the variations of the water pressure are small, also during a storm.

On the contrary, a tsunami is a shock wave that propagates through the entire water body, and that therefore may be registered at great depths. When the tsunami reaches shallow water the energy is concentrated, the pressure increases and a bigger wave starts to grow.

A tsunami is thereby easier and cheaper to detect at shallow water than at deeper. This may be used by locating the detectors in close connection to banks, islands and capes that protrudes from the coast. The only demand is that it is not so shallow that the pressure change from a tsunami is not separatable from the pressure change from an ordinary storm wave.

The device is located on the seabed 1. It consists of a stationary part/base unit 2, which accommodate means for detection of the fulfillment of a predetermined condition such as a specific pressure change, more precisely a pressure sensor 3, a processor 4 and a power source 5 as well as a number of attached parts 6, “couriers”, which may be released one by one. The detection means consists of a sensor 3 for the measuring of values of at least one quantity, a processor 4 for processing of said quantity values and a power source 5 that is connected to said processor 4. Said quantity is preferably pressure. The stationary part has a greater density than water and lies or stand therefore steadily on the seabed. The attached couriers have a density that is lower than that of water in order to by its own efforts ascend to the surface when they are released. The stationary part has a watertight pressure durable casing 7 and is preferably provided with a lifting device 8. If it is shaped as a spool shaped pressure bottle it may be made standing, having its heavier end on the seabed and its lighter end directed upwards.

The couriers are preferably at least eight in number and are attached to the stationary unit at such a way that they may be easily released at alarm. The figure shows the device in cross section, having one attached courier still in place and another one that just has been released and is on its way up. Thus, the inventive device comprises means for releasing the couriers from the base unit 2.

Each courier consists of a watertight pressure durable casing 9, and means in order to communicate to an external receiver that the same has been released from the base unit 2, more precisely a power source 10, a radio transmitter 11 as well as an antenna 12 mounted in the upper end of the courier. The courier also has fins 13 for a more stable ascension to the surface. Preferably, the courier has the centre of gravity thereof close to the rear end, in order to get the courier to float standing at the surface, having the antenna thereof a distance above the water. Hereby the range of transmission is improved.

The connection device 14 may be shaped in many different ways, e.g. a launching platform consisting of a bent tube, mounted to the stationary part. The release mechanism 15 may in that case consist of a small explosive charge that ejects the courier on a signal from the processor. Alternatively the couriers are placed in water tight compartments 16 having openable lids 17. The lids may either be opened electromechanically on by order from the processor, or be pushed away of a sudden inner over pressure, caused by a gas ampoule being triggered in the compartment in question. Further, the release mechanism/disengage mechanism 15 may be constituted by a displaceable pin connected to the base unit 2 or the courier 6, and an interacting lug connected to the other one of the courier 6 and the base unit 2.

Furthermore, the release mechanism is configured in such a way that the radio transmitter of the courier is activated at the same time. This may be achieved by closing an electric circuit by letting two pieces of plate metal, which previously were kept apart, recoil towards each other. It may also be achieved by letting the sea water get in contact with two cable connections on the bottom side or outside of the courier, and thereby closing an electrical circuit.

The pressure sensor measures continuously the water pressure and transmits the measuring values to the processor. In this the current pressure is compared with the preceding measuring value. If a measured pressure change is sufficiently large and sufficiently quick, the situation is classified as a passage of a dangerous large tsunami and the processor orders a release of one of the couriers. The processor may also analyze the measuring values by means of more advanced computational method for the purpose of getting a quicker and more reliable identification of tsunamis having a sufficient (dangerous) size.

The radio transmitter of the courier is thus activated upon the release and starts to transmit. When the courier reaches the surface the radio waves will reach the waiting receivers. A receiver on land may in its turn be directly connected to a siren that alarms the people being on the coastal region. It may also be connected to a larger tsunami warning system, and in practice it is advisable that it is connected to both. The transmitted signal may comprise more or leas information. In the most elementary case it is simply constituted by a code that the receiver respond to, but it may also comprise additional information, such as identity, position, etc. The transmitter and the receiver may also communicate by using any other type of wireless signal transfer, e.g. mobile telephone technique and the frequencies used therefore.

Thus, the inventive method comprises the steps of: measuring the value of at least one quantity several times at a stationary base nit 2, arranged to be located on the seabed; detecting whether a predetermined condition is fulfilled based on said measured quantity values; and if said condition is fulfilled release at least one courier 6 from said base unit 2; and that said courier 6 is activated and communicates to an external receiver that the same is released from the base unit 2. Said condition may be constituted by an exceeding of a first value, which is determined by a predetermined formula, and which is based on measured pressure differences during a limited period.

By placing an automatic tsunami detector at just the right distance outside an inhabited and vulnerable coastal region, the people may be alarmed in time in order to seek protection, since the above described process takes considerably shorter time than the time a tsunami needs to reach land.

A tsunami travels with a speed that is the result of multiplying the water depth and the acceleration of gravity, and thereby extracts the square root of that product. If the tsunami detector, for instance, is located 20 km out the coast and the mean depth is 200 meters, then the traveling time of the wave to the shore is about 10 minutes. The above described alarm process is in this case about 5 minutes, which gives an advance warning time of about 5 minutes.

Thus, the detector may in principal alarm for as many tsunamis that it has couriers. But since it is important to be able to test the equipment at regular intervals, and also exercise the reaction and response of the society upon an alarm, the processor may also have an instruction for this purpose.

At predetermined intervals, e.g. once or twice a year, the criteria are changed for a “passage of a dangerous large tsunami”. Instead of a response to a sufficiently large and quick pressure change, the device is now instructed to response to all pressure variations. As soon as two subsequent measuring values differ, the alarm is off and a courier is ordered to ascend. After this the device returns to its ordinary routine. The result is an intentional false alarm at a given time, an alarm that shows that all components in the system works; the pressure sensor, the battery, the processor, the release mechanism, the radio transmitter, the receiver, the siren, etc., each individually and all together.

### Feasible Modifications of the Invention

Like the device that is described in the SE patent application 0500007-0, this could measure other parameters than pressure, e.g. temperature, oxygen content, etc. and alarm for large changes of these. For instance, it could be part of an automatic environmental surveillance system. The processor may be programmed in order to respond if any measuring value is exceeded or underpassed. The difference is that the current device is not consumed after an alarm, and the function of which may be routine tested.

It should be pointed out that the inventive device shall comprise at least one courier, which is disengagably connected to the base unit.

1-16. (canceled)

17. A device for detection of and warning against tsunamis, characterized in that it comprises a stationary base unit (2) and at least one courier (6) disengagably connected to the base unit (2), means (3, 4, 5) for detection of the fulfillment of a predetermined condition, which condition is constituted by an exceeding of a first value, which is determined according to a predetermined formula, and which is based on measured pressure differences during a limited period, and means (15) for releasing the courier from the base unit when said condition is fulfilled, the courier (6) comprising means (10, 11, 12) in order to communicate to an external receiver that it is released from the base unit (2).

18. A device according to claim 17, wherein it comprises several couriers (6).

19. A device according to claim 17, wherein the detection means (3, 4, 5) is comprised in the base unit (2).

20. A device according to claim 17, wherein the detection means (3, 4, 5) is constituted by a sensor (3) for measuring the values of at least one quantity, a processor (4) for processing said quantity values, and a power source (5) connected to said processor (4).

21. A device according to claim 20, wherein said quantity is pressure.

22. A device according to claim 17, wherein the release means (15) is an explosive charge.

23. A device according to claim 17, wherein the release means (15) is constituted by a displaceable pin connected to the base unit (2) or the courier (6), and an interacting lug connected to the other one of the courier (6) and the base unit (2).

24. A device according to claim 17, wherein the release means (15) is constituted by an elastic outwardly openable lid (17), which seals a compartment for storing the courier (6), as well as a gas ampoule sized to create an overpressure that opens the lid upon triggering thereof.

25. A device according to claim 17, wherein the communication means (10, 11, 12) is constituted by a transmitter (11) and an antenna (12) for transmitting the information, and a power source (10) that is connected to said transmitter (11).

26. A device according to claim 17, wherein the courier (6) has an oblong shape having the center of gravity displaced towards a first end and that the antenna (12) is arranged in a second end of the courier.

27. A device according to claim 17, wherein the courier (6) has a lower density than water.

28. A warning system, characterized in that it comprises several devices according to claim 17 and an external receiver.

29. A method for detection of and warning against tsunamis, comprising the steps of:
measuring the value of at least pressure several times at a stationary base unit (2), which is arranged to be located on the seabed,
detecting whether a predetermined condition is fulfilled based on said measured quantity values,
that said condition is constituted by an exceeding of a first value, which is determined according to a predetermined formula, and which is based on measured pressure differences during a limited period,
releasing at least one courier (6) from the base unit (2) if said condition is fulfilled, and
that the courier (6) is activated and communicates to an external receiver that it is released from the base unit (2).

30. A method according to claim 29, wherein at predetermined intervals temporarily make said condition be constituted by two subsequent measuring values being different, for the purpose of testing the system by generating a false alarm.
